(19) United States
(12) Patent Application Publication
(10) Pub. No.: US 2017/0264498 A1
(43) Pub. Date: Sep. 14, 2017

(54) EVENT ESTIMATION DEVICE, EVENT ESTIMATION METHOD, AND RECORDING MEDIUM WHEREUPON EVENT ESTIMATION PROGRAM IS STORED

(71) Applicant: NEC Corporation, Tokyo (JP)

(72) Inventors: Kazuhiko ISOYAMA, Tokyo (JP); Etsuko ICHIHARA, Tokyo (JP); Junpei KAMIMURA, Tokyo (JP); Yoshiaki SAKAE, Tokyo (JP); Yuji KOBAYASHI, Tokyo (JP); Takashi NOMURA, Tokyo (JP); Koji KIDA, Tokyo (JP)

(73) Assignee: NEC Corporation, Tokyo (JP)

(21) Appl. No.: 15/510,332

(22) PCT Filed: Sep. 7, 2015
(86) PCT No.: PCT/JP2015/004523

§ 371 Date: Mar. 10, 2017

(30) Foreign Application Priority Data
Sep. 10, 2014 (JP) 2014-184088

(51) Int. Cl. H04L 12/24; H04L 12/26

(52) U.S. Cl. CPC H04L 41/142; H04L 43/04

(57) ABSTRACT

Disclosed are an event estimation device, etc., which are capable of estimating with high precision whether a communication is singular. Provided is an event estimation device (101), comprising: a model creation unit (102) which creates a model which, on the basis of a frequency with which a communication is executed, computes that a degree of singularity which represents the extent to which the communication is singular is high if the frequency is low, and computes that the degree of singularity is low if the frequency is high; and an estimation unit (103) which computes the degree of singularity by applying the model to the frequency relating to a given communication, and if the computed degree of singularity satisfies a standard, estimates that the given communication is singular, and if the computed degree of singularity does not satisfy the standard, estimates that the given communication is not singular.

### TECHNICAL FIELD

The present invention relates to a system and the like for detecting, for example, an irregularity event with regard to communication.

### BACKGROUND ART

Various methods are known as methods for monitoring communication in an information processing system. For example, PTL 1 discloses a detection device for monitoring a communication network. The detection device estimates a condition of the communication by estimating whether an event relating to a certain communication is irregular, based on a log relating to a communication event (hereinafter referred to as “event”) transmitted and received in a communication network.

### CITATION LIST

### Patent Literature

PTL 1: Japanese Unexamined Patent Application Publication No. 2010-531553

### SUMMARY OF INVENTION

### Technical Problem

However, according to the detection device disclosed in PTL 1, the accuracy for estimating whether the event is irregular is low. This is because, in the detection device, it is difficult to define an irregular communication by using a query and the like.

Such an irregular communication will be explained herein below. For convenience of explanation, it is assumed that a frequency of communication via TCP port 80 among multiple hosts (information processing devices, communication devices) is extremely low. The TCP stands for abbreviation of Transmission Control Protocol. In this case, for example, every time the detection device receives information indicating that a communication via TCP port 80 is executed, it is necessary to search all of recently executed communications via TCP port 80 between each host. The detection device specifies a communication via TCP port 80 from among all the communications, calculates the frequency of execution of the identified communication, and only in a case where a communication is executed between hosts having low calculated frequencies, the detection device estimates that the event relating to the received communication is irregular.

Therefore, it is a main object of the present invention to provide an event estimation device and the like capable of estimating with high accuracy whether a communication is irregular.

### Solution to Problem

In order to achieve the aforementioned object, as an aspect of the present invention, an event estimation device including:

model generation means for generating, based on a frequency of communications, a model for calculating an irregularity degree, that represents how irregular a communication is, which is high in case that the frequency is low and which is low in case that the frequency is high; and

estimation means for calculating the irregularity degree by applying the model to a frequency of a certain communication, and estimating that the certain communication is irregular in case that the calculated irregularity degree satisfies a criterion and that, otherwise, the certain communication is non-irregular.

In addition, as another aspect of the present invention, an event estimation method including:

generating, based on a frequency of communications, a model for calculating an irregularity degree, that represents how irregular a communication is, which is high in case that the frequency is low and which is low in case that the frequency is high, calculating the irregularity degree by applying the model to a frequency of a certain communication, and estimating that the certain communication is irregular in case that the calculated irregularity degree satisfies a criterion and that, otherwise, the certain communication is non-irregular.

Furthermore, the object is also realized by an associated event estimation program, and a computer-readable recording medium which records the program.

### Advantageous Effects of Invention

According to an event estimation device and the like of the present invention, whether a communication is irregular can be estimated with high accuracy.

### BRIEF DESCRIPTION OF DRAWINGS

FIG. 1 is a block diagram illustrating a configuration of an event estimation device according to a first example embodiment of the present invention.

FIG. 2 is a flowchart illustrating a flow of processing in the event estimation device according to the first example embodiment.

FIG. 3 is a flowchart illustrating a flow of processing performed in an interface.

FIG. 4 is a figure representing an example of a form capable of setting a query via a graphical user interface.

FIG. 5 is a figure representing an example of an aspect capable of setting a query by a text format.

FIG. 6 is a figure schematically illustrating an example of data structure.

FIG. 7 is a flowchart illustrating a flow of processing for storing graph information to a communication database.

FIG. 8 is a figure schematically illustrating an example of communication information.

FIG. 9 is a figure schematically illustrating an example of graph information.

FIG. 10 is a figure schematically illustrating an example of a model calculated in case that the type is “novelty”.

FIG. 11 is a figure schematically illustrating an example of a model calculated in case that the type is “time zone”.

FIG. 12 is a figure schematically illustrating an example of a model calculated in case that the type is “communication frequency”.

FIG. 13 is a figure schematically illustrating an example of a model calculated in case that the type is “communication quantity”.

FIG. 14 is a flowchart illustrating a flow of processing for generating a query.

FIG. 15 is a block diagram illustrating a configuration of a target information processing system in which an irregular event relating to communication is detected.

FIG. 16 is a block diagram illustrating a configuration of an event estimation device according to a second example embodiment of the present invention.

FIG. 17 is a flowchart illustrating a flow of processing of the event estimation device according to the second example embodiment.

FIG. 18 is a block diagram schematically illustrating a hardware configuration of a calculation processing apparatus capable of realizing an event estimation device according to each of the embodiments of the present invention.

### DESCRIPTION OF EMBODIMENTS

Subsequently, example embodiments for carrying out the present invention will be explained in details with reference to drawings.

### First Example Embodiment

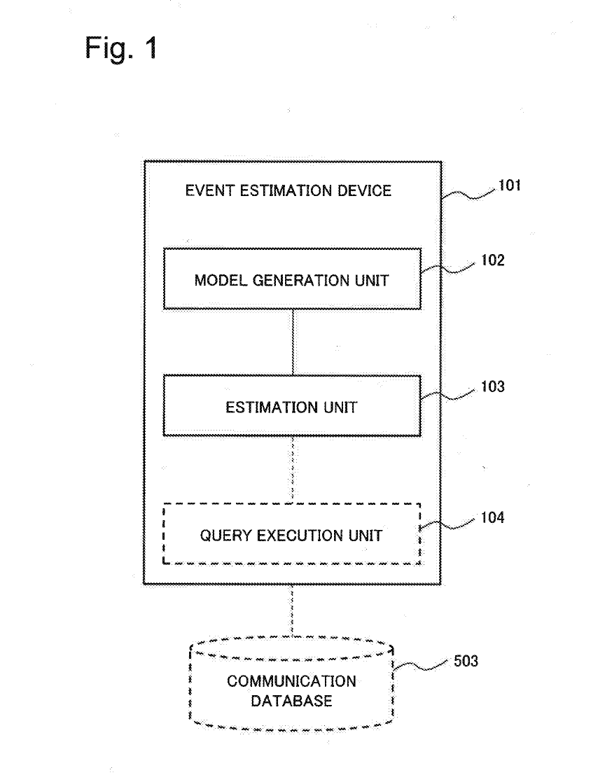

A configuration of an event estimation device 101 according to a first example embodiment of the present invention will be explained in details with reference to FIG. 1. FIG. 1 is a block diagram illustrating a configuration of the event estimation device 101 according to the first example embodiment of the present invention.

The event estimation device 101 according to the first example embodiment includes a model generation unit 102 and an estimation unit 103. The event estimation device 101 may further include a query execution unit 104.

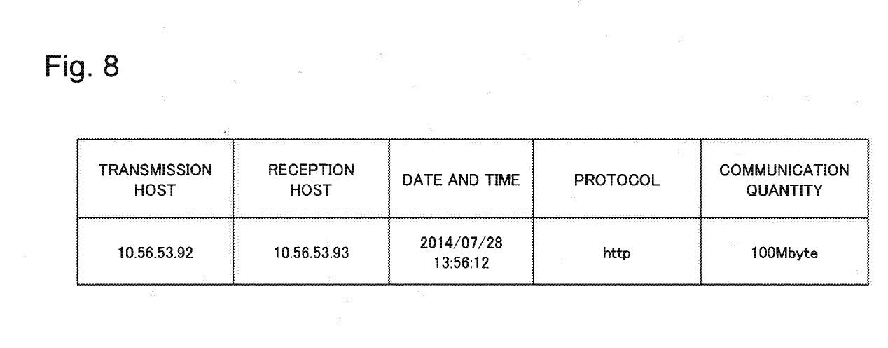

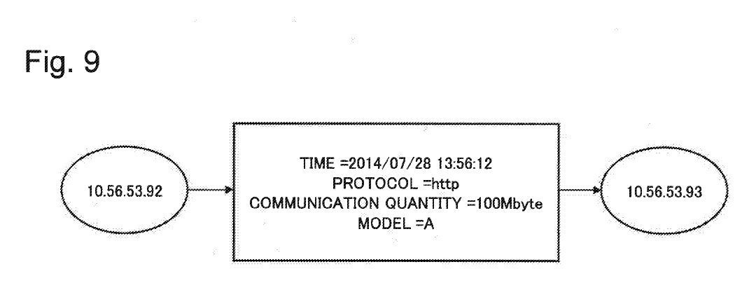

In a communication database 503, graph information (explained later, for example, FIG. 9) obtained by converting communication information (explained later, for example, FIG. 8) about communication executed by communication bodies are stored. The event estimation device 101 can read the graph information and the like from the communication database 503 and can store the graph information and the like to the communication database 503

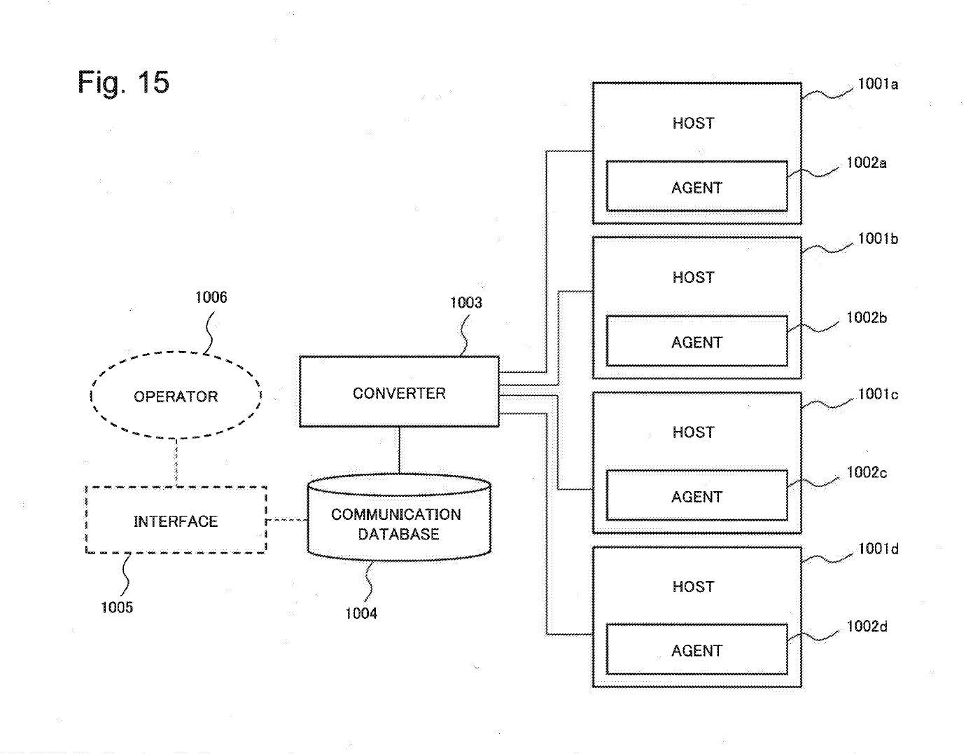

First, a target information processing system, in which an irregular event relating to communication is detected in accordance with a result estimated by the event estimation device 101 and the like, will be explained with reference to FIG. 15. FIG. 15 is a block diagram illustrating a configuration of a target information processing system in which an irregular event relating to communication is detected.

For convenience of explanation, it is assumed that, in the information processing system, multiple information processing devices (which are represented as a host 1001a to a host 1001d) execute communication with each other. In this case, the event estimation device 101 according to the present example embodiment estimates whether communications executed among the host 1001a to the host 1001d are irregular.

The host 1001a to the host 1001d include an agent 1002a to an agent 1002d, respectively, for monitoring communications between the hosts. For example, the agent 1002a monitors communication executed by the host 1001a. The agent 1002b monitors communication executed by the host 1001b. The agent 1002c monitors communication executed by the host 1001c. The agent 1002d monitors communication executed by the host 1001d.

The agent 1002a transmits the communication information to a converter 1003 in accordance with transmission or reception of information (hereinafter referred to as “communication information”) by the host 1001a. Similarly to the agent 1002a, the agent 1002b to the agent 1002d also monitor communication executed by the host including own agent, respectively.

The converter 1003 receives communication information transmitted by each agent, and analyzes the received communication information. For example, the converter 1003 identifies, in the received communication information, an identifier representing a transmission-side host (hereinafter referred to as “transmission-side identifier”), an identifier representing a reception-side host (hereinafter referred to as “reception-side identifier”), and information representing a content transmitted and received in the communication. Subsequently, the converter 1003 sets the identified transmission-side identifier as a label of a starting node and sets the identified reception-side identifier as a label of an ending node. The converter 1003 generates a directed graph by setting the identified information as the labels of a directed edge extending from the starting node to the ending node. More specifically, the converter 1003 uses the identified reception-side identifier, the identified reception-side identifier, and the identified information to generate graph information representing an aspect of the communication. The converter 1003 stores the generated graph information to a communication database 1004. Hereinafter, a node may also be referred to as a vertex.

An operator 1006 sets, into an interface 1005, a query for retrieving information relating to communication satisfying a predetermined condition from among target communications for being monitored. For example, in a case where the operator 1006 monitors “communication transmitted via TCP port 80”, the operator 1006 sets, in the interface 1005, a query described with a predetermined criteria such as “TCP port=80”. In accordance with a certain timing (e.g. a query is set, search is performed with a regular interval, a new communication is executed, and the like), the interface 1005 specifies, in the communication database 1004, information relating to communication satisfying a criteria in the set query. When a communication matching with the criteria in the set query is specified, the interface 1005 outputs information about the specified communication to the operator 1006.

Similarly to the communication database 1004 explained above, the communication database 503 illustrated in FIG. 1 stores graph information (for example, FIG. 9, explained later) generated based on communication information indicating communication executed among communication bodies. More specifically, in the communication database 503, communication information relating to executed communication are stored. The communication database 503 (hereinafter referred to as “DB”) may be a DB for storing information in accordance with other formats such as a relational database.

In each example embodiment of the present application, communication bodies represent information processing devices capable of performing communication via a communication network. Alternatively, the communication bodies represent network devices capable of performing communication via a communication network. A network device is, for example, computers such as a personal computer or a server, a device such as a network printer, a firewall, a router, a network switch, or the like.

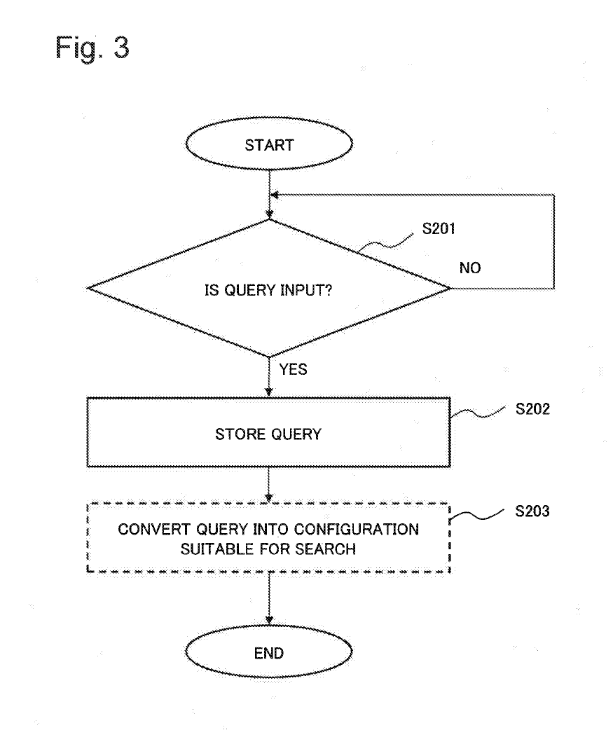

Processing in the interface 1005 in a case where a query for retrieving information relating to communication satisfying a predetermined criteria is set will be explained with reference to FIG. 3. FIG. 3 is a flowchart illustrating a flow of processing performed in the interface 1005.

In case that a query is input (YES in step S201), the query interface (hereinafter also referred to as “IF”) 1005 stores the query (step S202). The interface 1005 may convert the query into a configuration suitable for searching the query (step S203). For example, the interface 1005 may convert the query into a search tree, or may convert the query into an aspect for performing search using a hash function.

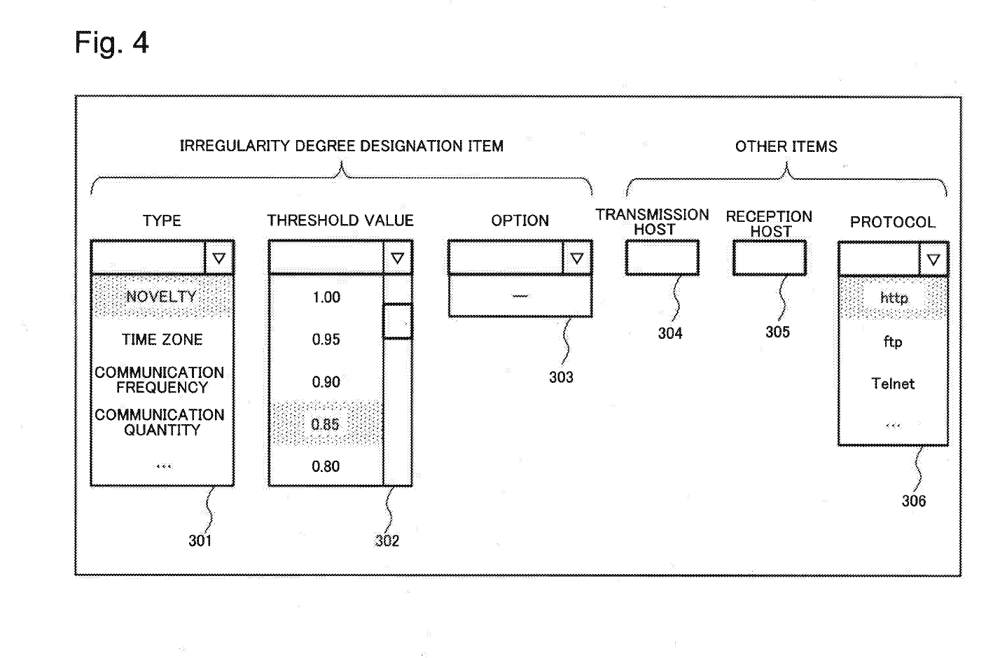

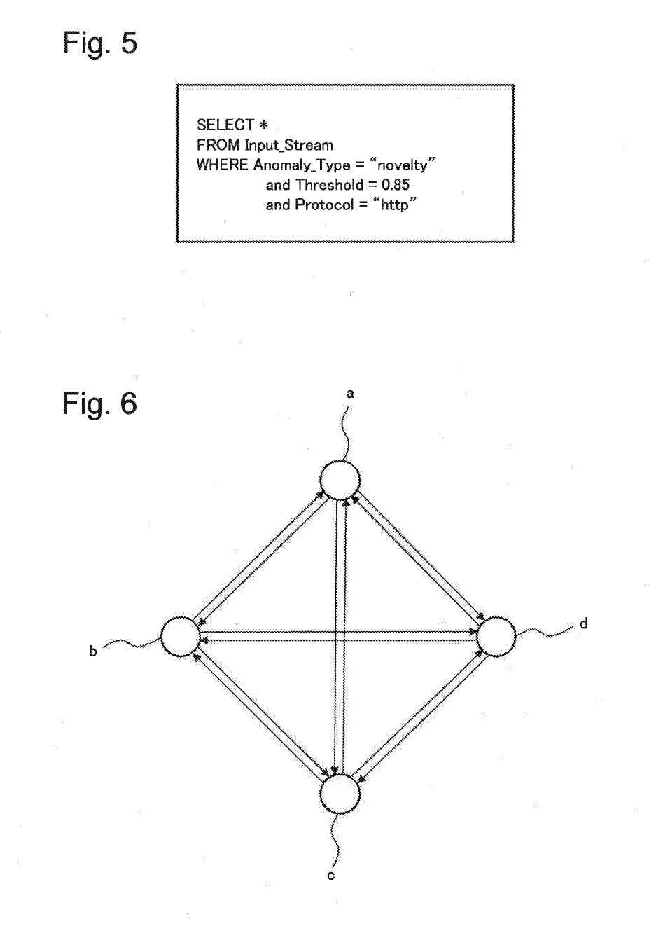

Subsequently, a query which is input into the interface 1005 will be explained with reference to FIG. 4 and FIG. 5. FIG. 4 is a figure representing an example of a form capable of setting a query via a GUI (graphical user interface). FIG. 5 is a figure representing an example of an aspect capable of setting a query by a text format.

When roughly classified, the GUI exemplified in FIG. 4 includes two types of IFs. One of the IFs is an IF capable of setting an item representing the irregularity degree (hereinafter referred to as “irregularity degree designation item”) representing the extent (degree) as to how much a communication event (hereinafter referred to as “communication”) is irregular. The other of the IFs is an information IF capable of setting items other than the irregularity degree in communication.

The irregularity degree designation item further includes a type IF 301 for setting an index representing a type relating to the irregularity degree (explained later), a threshold value IF 302 for setting a threshold value serving as a reference estimating whether communication is irregular, and an option IF 303 for setting an option relating to the irregularity degree.

Via the type IF 301, a type relating to a function of calculating the irregularity degree, with which whether a communication is irregular is estimated, is set from among multiple choices. For example, a type “novelty” represents a function of estimating that the communication is irregular in case that communication is executed between communication bodies that usually do not execute communication. A “time zone” included in the type IF 301 represents a function of estimating that the communication among multiple communication bodies is irregular in case that communication is executed in a time zone that communication is usually not executed among them. The time zone is a certain time of a day, a certain day of a week, a certain day of a month, and the like, and can be set via the option IF 303.

A “communication frequency” included in the type IF 301 represents a function of estimating that the communication is irregular in case that the cycle of communication executed among multiple communication bodies is different from a cycle of communication executed normally among them. A “communication quantity” included in the type IF 301 represents a function of estimating that the communication is irregular in case that the communication quantity of the communication executed between communication bodies is different from a communication quantity of communication executed normally between them.

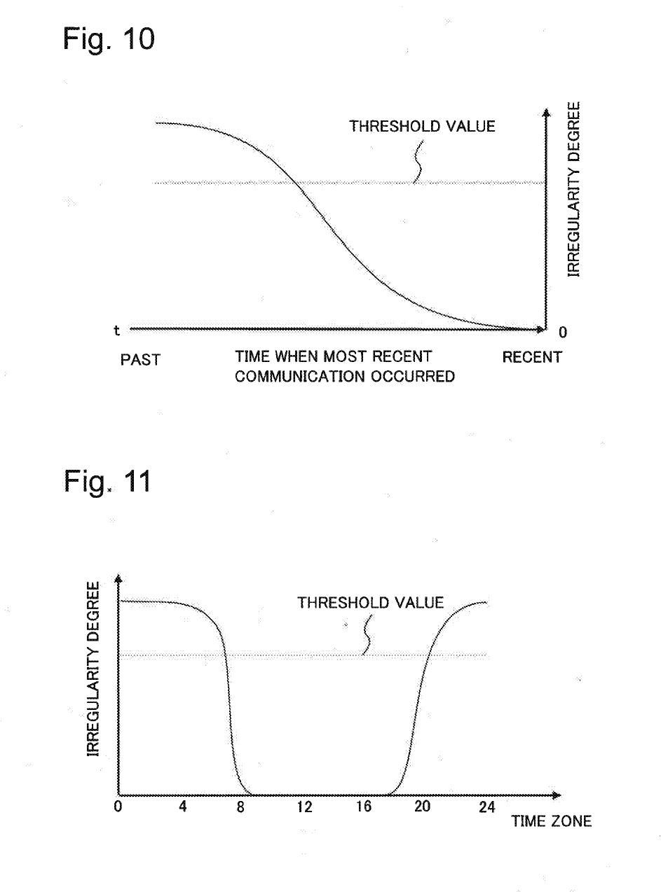

A threshold value, which represents a criterion for estimating whether a communication is irregular, for the irregularity degree of a type set via the type IF 301 can be set via the threshold value IF 302. The threshold value is, for example, a value representing a criterion for estimating whether the communication is irregular by using a model (explained later, for example, FIG. 10 to FIG. 13) associated with an executed communication. Methods for defining the threshold value include not only the method of setting a value with a pull-down method by using the threshold value IF 302 just like a form exemplified in FIG. 4, but also a method for inputting a numerical value with a text form, and a method for changing a setting numerical value with a scroll button and the like.

The option IF 303 allows an input of information that needs to be additionally set with regard to the irregularity degree of the type setting with the type IF 301. The option IF 303 may be shown as necessary. For example, in case that the “time zone” is selected with the type IF 301, the option IF 303 may be shown. For example, the option IF 303 can set, as a time zone, a certain time of a day (Time of the Day), a certain day of a week (Day of Week), a certain day of a month (Day of Month), or the like.

It is assumed that, in case that the “communication quantity” is selected with the type IF 301, the option IF 303 is shown. Via the option IF 303, a period for measuring the communication quantity can be allowed. The number of items that can be set via the option IF 303 is not limited to one, and multiple items may be set as necessary.

The information IF includes a transmission host IF 304, a reception host IF 305, and a protocol IF 306. The information IF may include other IFs, and is not limited to the following explanation.

Via the transmission host IF 304, communication bodies transmitting information (hereinafter referred to as “transmission host”) relating to communication for being searched can be set. Via the reception host IF 305, communication bodies receiving information (hereinafter referred to as “reception host”) relating to communication for being searched is set.

Examples of methods for setting communication bodies include a method for designating, an IP (internet protocol) address, a method for designating a MAC (Media Access Control) address, a method for designating a host name, or the like.

It is not always necessary to set information for designating the transmission host via the transmission host IF 304. It is not always necessary to set information for designating the reception host via the reception host IF 305. For example, in case that the transmission host and reception hosts are designated, the event estimation device 101 estimates whether a communication between the designated transmission host and the designated reception host is irregular by using a query exemplified in FIG. 4. For example, in case that the transmission host and the reception host are not designated, the event estimation device 101 may estimate whether communications relating to all the hosts are irregular.

A protocol relating to target communication for being determined as to whether it is irregular can be designated via the protocol IF 306. Examples of methods for designating a protocol include a method for designating a protocol name, a method for designating a TCP/UDP (user datagram protocol) port number and the like.

The event estimation device 101 estimates whether a communication executed in accordance with the designated protocol is irregular. In case that a protocol is not designated, the event estimation device 101 may estimate whether a communication is irregular without limiting the protocol.

In the form exemplified in FIG. 4, a hatched region indicates a selected item. More specifically, the form exemplified in FIG. 4 shows a query for retrieving information relating to communications satisfying a criterion where the type of the irregularity degree is “novelty”, the threshold value of the irregularity degree is “0.85”, and the protocol is http. With the items selected in the form, when, for example, an enter button (not illustrated) is pressed down, a query according to the selected items is set in the event estimation device 101.

The form may include, for example, an IF capable of inputting a port number or the like. The form does not always need to include all the items such as the type IF 301. More specifically, the form is not limited to the aspect exemplified in FIG. 4

In FIG. 5, a query for retrieving information satisfying a predetermined criteria are described by a text. In FIG. 5, “SELECT” indicates a command for retrieving information satisfying a predetermined criteria shown in “WHERE” and its subsequent clause from “Input Stream” shown in “FROM” field. For example, in “WHERE” and its subsequent clause, an item 1 to an item 3 are combined by using “and” representing a logical multiplication operation. More specifically, “WHERE” and its subsequent clause includes:

item 1: a communication of which type (“Anomaly Type” in FIG. 5) is novelty (“novelty” in FIG. 5),

item 2: a communication of which threshold value (“Threshold” in FIG. 5) is 0.85, and

item 3: a communication of which protocol (“Protocol” in FIG. 5) is “http”. “HTTP” stands for abbreviation of Hypertext Transfer Protocol.

More specifically, the query exemplified in FIG. 5 is a query for retrieving information relating to communications satisfying the three criteria: a criteria that the type of the irregularity degree is novel, a criteria that the threshold value of the irregularity degree is 0.85, and a criteria that the protocol is “http”.

For convenience of explanation, it is assumed that a basic syntax relating to a query is based on EPL (Event Processing Language). However, in each example embodiment of the present invention, the query exemplified in FIG. 5 includes not only a query based on EPL but also a parameter relating to the irregularity degree.

In case that a query is designated with a text format, a type, a threshold value, an option, or the like can be designated just like the case of designating a query via GUI.

The example illustrated in FIG. 5 is a query for detecting an irregularity of communication according to HTTP protocol, based on two criteria: the type is “novelty” (“Anomaly Type”=“novelty”), the threshold value is “0.85” (Threshold=0.85). In FIG. 5, the HTTP protocol is designated with “Protocol=“http””.

Subsequently, communication information and graph information relating to processing performed in the event estimation device 101 according to the present example embodiment will be explained. First, the communication information will be explained with reference to FIG. 8. FIG. 8 is a figure schematically illustrating an example of communication information.

The communication information is information where for example, a device identifier capable of identifying a transmission host executing communication, a device identifier capable of identifying a reception host executing communication, a date and time when communication is executed, a protocol of the communication, a communication quantity transmitted and received in the communication, and the like are associated with each other. This represents that information having the communication quantity is communicated from the transmission host to the reception host at the date and time in accordance with the protocol of the communication. For example, in the communication information exemplified in FIG. 8, a device identifier “10.56.53.92” indicating the transmission host, a device identifier “10.56.53.93” indicating the reception host, a date and time “2014/07/28 13:56:12”, a protocol “http”, and a communication quantity “100 Mbyte (Megabyte)” are associated. This represents that information with having “100 Mbyte” size is communicated from the transmission host “10.56.53.92” to the reception host “10.56.53.93” in accordance with the “http” protocol at the date and time “2014/07/28 13:56:12”.

Subsequently, the graph information will be explained with reference to FIG. 9. FIG. 9 is a figure schematically illustrating an example of graph information.

The graph information is information where a device identifier capable of identifying a transmission host, a device identifier representing a reception host, and communication information about communication executed between the transmission host and the reception host are associated. For example, in the communication information, a time for communication, a protocol relating to the communication, and a communication quantity (data size) transmitted and received in the communication are associated. In the communication information, a model generated with regard to the communication (exemplified in FIG. 10 to FIG. 13, explained later) may be further associated.

In the graph information exemplified in FIG. 9, a single vertex having a circular shape represents a communication body. The vertex is attached with a label of a device identifier representing the communication body. For example, the graph information includes a vertex “10.56.53.92” and a vertex “10.56.53.93”. The vertex “10.56.53.92” represents a device identified by using the device identifier “10.56.53.92”. The vertex “10.56.53.93” represents a device identified by using the device identifier “10.56.53.93”.

In the graph information, the two device identifiers are associated by using an aspect in which the two vertices are connected via arrows. The arrow represents communication executed between devices represented by each of the device identifiers. For example, in the graph information exemplified in FIG. 9, an arrow from the vertex “10.56.53.92” to the vertex “10.56.53.93” indicates that information is transmitted from the device identifier “10.56.53.92” to the device identifier “10.56.53.93”.

Further, in the graph information, communication information about the communication is attached as a label of an edge representing the communication. For example, in the graph information exemplified in FIG. 9, the label of the edge representing the communication includes a date and time “2014/07/28 13:56:12”, a protocol “http”, a communication quantity “100 M byte”, and a model “A”. This represents that, in a case where the device identifier “10.56.53.92” communicates with the device identifier “10.56.53.93”, the communication is executed at the date and time “2014/07/28 13:56:12”, the protocol of the communication is “http”, and the communication quantity of the communication is “100 M byte”. Further, this indicates that, in a case where the device identifier “10.56.53.92” communicates with the device identifier “10.56.53.93”, the model relating to the communication is “A”. As described above, in the graph information, the label relating to the edge representing the communication may not necessarily include a model.

More specifically, in the graph information, for example, the device identifier for identifying the transmission host, the device identifier representing the reception host, and the communication information about communication executed between the transmission host and the reception host are associated by using the graph explained above.

Subsequently, processing for achieving processing relating to a graph in the information processing device will be explained. For example, the graph is expressed by using adjacent vertex information where a vertex identifier representing a certain vertex and a vertex identifier representing a vertex connected to (adjacent to) the certain vertex are associated. The graph may be represented by using vertex edge information where a vertex identifier representing a certain vertex and an edge identifier representing an edge connected to the certain vertex are associated.

In a case where a graph is represented by adjacent vertex information, information attached to a certain vertex (for example, the device identifier explained above) is represented by vertex label information where an identifier representing the certain vertex and the information are associated. An identifier representing the certain vertex and an information identifier representing the information may be associated in the vertex label information.

In a case where a graph is represented by vertex edge information, information attached to a certain edge (for example, the date and time, the model, and the like explained above) is represented by edge label information where an edge identifier representing the certain edge and the information are associated. In a case where a graph is represented by vertex edge information, information attached to a certain edge is represented by edge label information where an edge identifier representing the certain edge and the information are associated.

In a case where information is attached to both of the vertex and the edge in the graph, the graph may be represented by the vertex label information explained above and the edge label information explained above. The aspect for representing the graph is not limited to the example explained above.

For convenience of explanation, in each example embodiment of the present invention, processing executed by each unit is represented as processing for the graph, but the processing is realized as processing executed with regard to information such as the vertex edge information and the like described above.

Subsequently, processing in the event estimation device 101 according to the present example embodiment will be explained. The processing in the event estimation device 101 roughly includes processing for generating a model and processing for determining whether a communication is irregular based on the generated model.

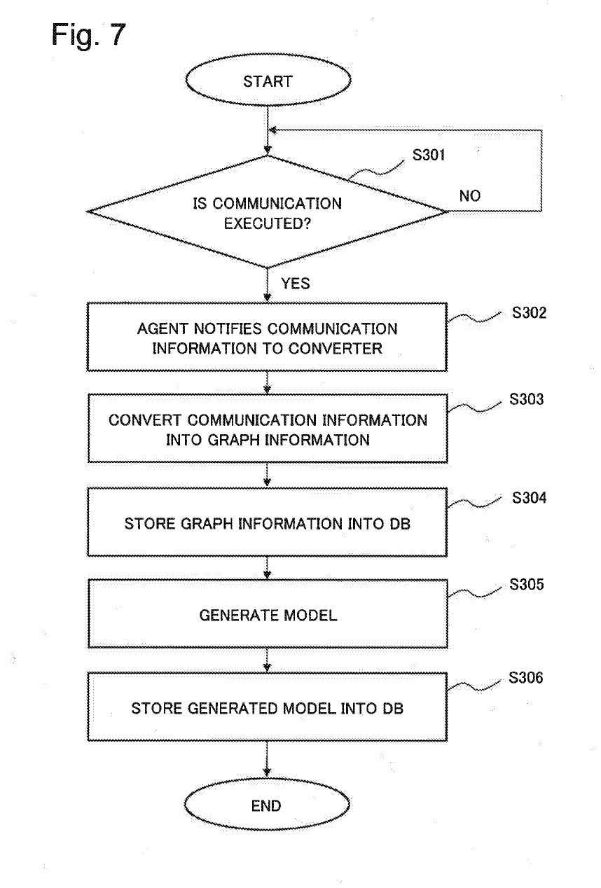

First, processing for generating a model in the event estimation device 101 according to the present example embodiment will be explained. The model generation unit 102 generates a model to be referred to (explained later, for example, FIG. 10 to FIG. 13) in a process for estimating a communication irregularity on the base of a frequency of communication. A procedure for generating a model in the model generation unit 102 will be explained later with reference to FIG. 7. The model generation unit 102 generates graph information including the generated model, and stores the generated graph information to the communication database 503.

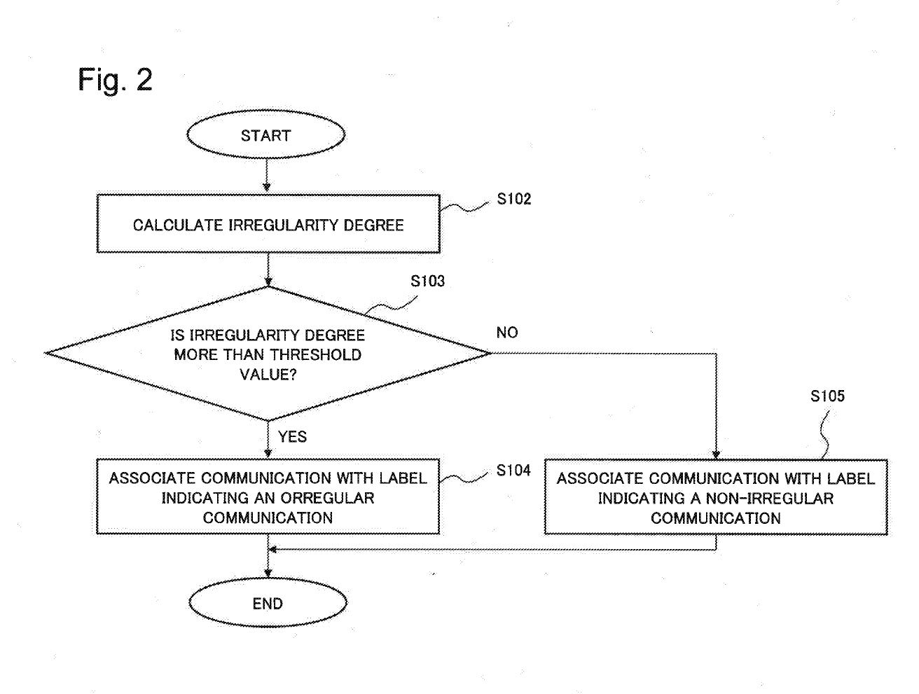

Subsequently, processing for determining whether a communication is irregular based on the generated model in the event estimation device 101 according to the present example embodiment will be explained with reference to FIG. 2. FIG. 2 is a flowchart illustrating a flow of processing in the event estimation device 101 according to the first example embodiment.

The processing in the event estimation device 101 will be explained with reference to an example of a case where the information processing system exemplified in FIG. 15 executes communication processing for transmitting information from the transmission host to the reception host. The estimation unit 103 selects communication information including a protocol, a model, and the like that are associated with the device identifier of the transmission host and the identifier of the reception host on the basis of the graph information stored in the communication database 503.

Subsequently, in accordance with the query exemplified in FIG. 4 or FIG. 5, the estimation unit 103 calculates parameters (for example, a communication frequency, a communication quantity, and the like) that are inputs into a model included in the communication information on the base of the selected communication information. For example, in case that a type “communication frequency” is designated in the query, the estimation unit 103 classifies the data and time included in the identified communication information into a predetermined time zone, calculates the number of communications executed in the time zone to calculate the communication frequency. For example, in a case where the type “communication quantity” is designated in the query, the estimation unit 103 reads the communication quantity included in the identified communication information.

The estimation unit 103 applies the read model to the calculated parameter to calculate the irregularity degree (step S102). Subsequently, the estimation unit 103 determines whether the calculated irregularity degree satisfies a criterion (step S103). The criterion is whether the irregularity degree is more than a predetermined threshold value.

In case that the calculated irregularity degree is more than the threshold value (YES in step S103), the estimation unit 103 associates the communication with a label indicating an irregular communication (step S104). In case that the calculated irregularity degree does not satisfy the criterion (NO in step S103), the estimation unit 103 associates the communication with a label indicating a non-irregular communication (step S105). Although the estimation unit 103 associates the communication with the label in step S104 or step S105, the estimation unit 103 may classify the communications into irregular communication and non-irregular communication on the base of whether the irregularity degree is more than the threshold value.

The processing for calculating the parameter in the processing shown in step S102 may be executed in advance, and in this case, for example, a parameter relating to the communication processing in the data stored in the communication database 503 (data structure is exemplified in FIG. 6) is specified. FIG. 6 is a figure schematically illustrating an example of data structure.

With reference to FIG. 6, an example in which a data structure is represented by a graph is shown. The graph exemplified in FIG. 6 includes a vertex a to a vertex d and arrows (edges) connecting two vertices. The vertices represent communication bodies. Each vertex is attached with a label by an identifier of each communication body. Each arrow represents a communication between adjacent vertices (i.e., communication bodies). A label representing information such as a protocol relating to the communication may be attached to an edge. For example, an arrow from the vertex a to the vertex b indicates that the communication body a transmits information to the communication body b. An arrow extending from the vertex d to the vertex c indicates that the communication body d transmit information to the communication body c.

More specifically, the graph indicates an aspect of communication executed among multiple communication bodies. For example, in a case where communication processing is executed to transmit information from the vertex a to the vertex b, the model generation unit 102 may specify an arrow from the vertex a to the vertex b, and may update a frequency attached as a label of the identified arrow on the base of the date and time of the communication processing. The data structure exemplified in FIG. 6 is achieved by using, for example, the vertex edge information and the like explained above.

Subsequently, processing for generating graph information relating to communication executed by communication bodies and storing the graph information to the communication database 503 will be explained with reference to FIG. 7. FIG. 7 is a flowchart illustrating a flow of processing for storing graph information to the communication database 503.

For convenience of explanation, the communication bodies are assumed to be hosts (i.e., a host a to a host d). The host a to the host d are assumed to have an agent a to an agent d, respectively, for monitoring communication of the hosts. More specifically, the agent a to the agent d are assumed to be resident on the host a to the host d, respectively.

In a case where the host a executes communication (i.e., communication occurs) (YES in step S301), the agent a notifies communication information about the communication (exemplified in FIG. 8) to the converter (step S302). Each of the agent b to the agent d executes processing similar to the processing executed by the agent a with regard to the communication of the host having the agent.

The converter 1003 reads the identifier of the transmission host relating to a certain communication, the identifier of the reception host relating to the communication, the date and time when the communication is executed, the protocol of the communication, and the communication quantity of the communication from the communication information received from each agent. The converter 1003 convert the read information to the graph information (for example, FIG. 9) that includes vertices, whose labels represent the read device identifier of the transmission host and the read device identifier of the reception host, and edges whose labels represent the date and time, the protocol, and the communication quantity (step S303). The converter 1003 stores the generated graph information to the communication database 503 (corresponding to the communication database 1004 in FIG. 15) (step S304).

For example, in a case where the graph information is updated in the communication database 503, the model generation unit 102 may generate a model, based on the base of the updated graph information. For example, the model generation unit 102 executes processing such as reading a time from the updated graph information, classifying the read time into each time zone, and calculating the frequency of communication executed within each time zone, so that the model generation unit 102 generates a model (step S305). The details of the processing for generating the model will be explained later in details for each of the types of “novelty”, “time zone”, and the like. The model generation unit 102 stores the generated model into the communication database 503 as a label of an edge connecting the identifier of the transmission host and the identifier of the reception host (step S306).

A procedure for generating a model in step S305 in the model generation unit 102 will be explained in a more specific manner. The processing for generating a model in the model generation unit 102 will be explained with reference to an example where the type is, for example, “novelty”, “time zone”, “communication frequency”, and “communication quantity”, respectively.

Processing for generating a model in the model generation unit 102 in case that the type is “novelty” will be explained.

The model generation unit 102 generates a histogram representing a history of communication frequency, based on graph information stored in the communication database 503. In this case, for example, the model generation unit 102 reads the date and time (timing) relating to communication executed in accordance with a certain protocol between the transmission host and the reception host from the graph information. The model generation unit 102 classifies the read timing into a predetermined period, and calculates the communication frequency in the period, so that the model generation unit 102 generates the histogram.

For example, in case that there is a period in which the frequency is zero, the model generation unit 102 may add a small value (for example, 1) to the frequency of each period for which the histogram is calculated. In this case, for example, even in a case where the frequency is not include in the graph information stored in the communication database 503, the model generation unit 102 calculates the frequency on the basis of the small value. In this case, the model generation unit 102 generates a model where execution of communication in the period is assumed. Therefore, the model generation unit 102 generates the appropriate histogram.

The model generation unit 102 generates a model by, e.g., switching a high level of frequency and a low level of frequency in the histogram. For example, in case that the frequency in the histogram is high, the model generation unit 102 sets the irregularity degree low. In case that the frequency in the histogram is low, the model generation unit 102 sets the irregularity degree high. As a result, model generation unit 102 generates a model exemplified in FIG. 10. FIG. 10 is a figure schematically illustrating an example of a model calculated in case that the type is “novelty”. The horizontal axis of FIG. 10 represents the timing explained above, and indicates the latest timing to a right side. The vertical axis of FIG. 10 represents the irregularity degree, and indicates a higher degree of irregularity to an upper side. The model exemplified in FIG. 10 indicates that the irregularity degree is higher as a timing is closer to the latest timing, and therefore, the frequency is higher as a timing is closer to the latest timing. The model generation unit 102 generates the graph information including the generated model as a label of an edge in the graph (for example, FIG. 9), and stores the generated graph information to the communication database 503.

In case that the type is “novelty”, the estimation unit 103 calculates the frequency of communication executed during a certain period. The estimation unit 103 reads a model included in the graph information generated by the model generation unit 102 on the base of a result obtained by referring to the communication database 503 and applies the read model to the calculated frequency, so that the estimation unit 103 calculates the irregularity degree. In this case, in case that communication is executed in a period with low frequency, the estimation unit 103 estimates that the communication is irregular. Therefore, as illustrated in FIG. 10, the earlier the timing of the last communication is, the higher the calculated irregularity degree is. More specifically, in the case of the model exemplified in FIG. 10, in case that an elapsed time from a timing of a certain communication to a timing of a latest communication similar to the certain communication is longer, the estimation unit 103 estimates that the certain communication is irregular.

Processing for generating a model in the model generation unit 102 in case that the type is “time zone” and further the option is “Time of the Day” will be explained.

The model generation unit 102 generates a histogram representing a history of communication frequency in a certain time zone on the base of the graph information stored in the communication database 503. In this case, for example, the model generation unit 102 classifies a timing of communication between the transmission host and the reception host in accordance with a certain protocol into multiple time zones, and calculates the frequency in the time zones, so that the model generation unit 102 generates the histogram. For example, the model generation unit 102 generates a histogram relating to each of time zones generated by dividing a day.

The model generation unit 102 generates a model as exemplified in FIG. 11 by executing processing similar to the above processing with regard to the histogram. FIG. 11 is a figure schematically illustrating an example of a model calculated in case that the type is “time zone”. The horizontal axis of FIG. 11 represents the time zone, and indicates a later time zone to a right-hand side. The vertical axis of FIG. 11 represents the irregularity degree, and indicates a higher degree of irregularity to a higher side. The model generation unit 102 generates the graph information including the generated model as a label of an edge in the graph (for example, FIG. 9), and stores the generated graph information to the communication database 503.

The estimation unit 103 calculates a time zone including a timing of a certain communication. The estimation unit 103 reads a model included in the graph information generated by the model generation unit 102 from the communication database 503 and applies the read model to the calculated time zone, so that the estimation unit 103 calculates the irregularity degree. Hereinafter, the estimation unit 103 estimates whether a communication is irregular by executing processing similar to the above processing.

In case that the type is “time zone”, the estimation unit 103 estimates that a communication is irregular, when the communication is executed in a time zone where the communication frequency is low. More specifically, in the example illustrated in FIG. 11, in a time zone where the communication frequency is higher (daytime), the estimation unit 103 estimates that the communication is non-irregular. On the contrary, in a time zone where the communication frequency is lower (night time), the estimation unit 103 estimates that the communication is irregular.

Processing for generating a model in the model generation unit 102 in case that the type is “communication frequency” will be explained.

The model generation unit 102 generates a histogram representing a history of communication frequency on the base of the communication information stored in the communication database 503. In this case, for example, the model generation unit 102 calculates a time interval of communication between the transmission host and the reception host in accordance with a certain protocol. The model generation unit 102 divides the calculated interval into sections, and calculates the frequency in each of the sections, so that the model generation unit 102 generates a histogram.

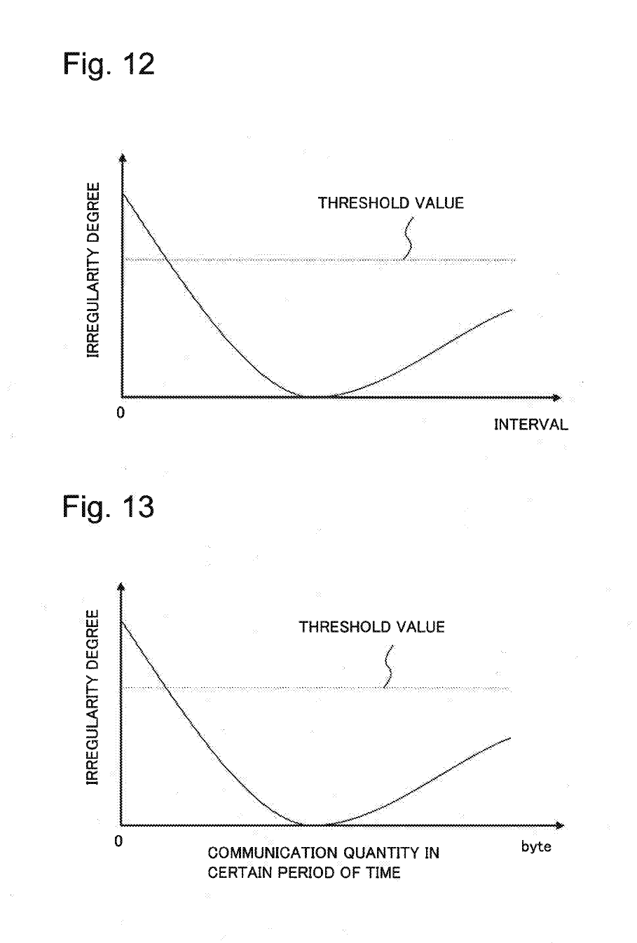

The model generation unit 102 generates a model as exemplified in FIG. 12 by executing processing similar to the above processing with regard to the histogram. FIG. 12 is a figure schematically illustrating an example of a model calculated in case that the type is “communication frequency”. The horizontal axis of FIG. 12 represents the interval (time interval) of communication, and indicates a longer interval to a right-hand side. The vertical axis of FIG. 12 represents the irregularity degree, and indicates a higher irregularity degree to a higher side. The model generation unit 102 generates the graph information including the generated model as a label of an edge in the graph (for example, FIG. 9), and stores the generated graph information to the communication database 503.

The estimation unit 103 calculates an interval of a certain communication with regard to the certain communication. The estimation unit 103 reads a model included in the graph information generated by the model generation unit 102 from the communication database 503 and applies the read model to the calculated communication interval, so that the estimation unit 103 calculates the irregularity degree. Hereinafter, the estimation unit 103 estimates whether a communication is irregular by executing processing similar to the above processing.

As described above, in case that the type is “communication frequency”, the model generation unit 102 calculates an interval between timings of two communications. For example, the event estimation device 101 may include a state (not shown) storing a timing of an immediately preceding communication.

Processing for generating a model in the model generation unit 102 in case that the type is “communication quantity” will be explained.

The model generation unit 102 generates a histogram representing a history of communication frequency on the base of the graph information stored in the communication database 503. In this case, for example, the model generation unit 102 reads communication quantities transmitted and received in a communication between the transmission host and the reception host in accordance with a certain protocol. Subsequently, the model generation unit 102 classifies the read communication quantities into sections, and calculates the frequency in each of the sections to generate a histogram. In this case, the frequency represents a frequency of a certain communication quantity measured with regard to communication executed between the transmission host and the reception host in accordance with a certain protocol within a certain time.

The model generation unit 102 generates a model as exemplified in FIG. 13 by executing processing similar to the above processing with regard to the histogram. FIG. 13 is a figure schematically illustrating an example of a model calculated in case that the type is “communication quantity”. The horizontal axis of FIG. 13 represents the communication quantity, and indicates a larger communication quantity to a right-hand side. The vertical axis of FIG. 13 represents the irregularity degree, and indicates a higher irregularity degree to a higher side. The model generation unit 102 generates the graph information including the generated model as a label of an edge in the graph (for example, FIG. 9), and stores the generated graph information to the communication database 503.

The estimation unit 103 calculates a communication quantity transmitted and received in a certain communication. The estimation unit 103 reads a model generated by the model generation unit 102 from the communication database 503 and applies the read model to the calculated communication quantity, so that the estimation unit 103 calculates the irregularity degree. Hereinafter, the estimation unit 103 estimates whether a communication is irregular by executing processing similar to the above processing.

In case that the type is “communication quantity”, the communication is likely to be irregular when the communication quantity is different from a communication quantity transmitted and received normally. Therefore, the model generation unit 102 generates a model in which degree of irregularity is lower in a case where the communication quantity is closer to a communication quantity transmitted and received normally, and the model generation unit 102 generates a model in which degree of irregularity is higher in a case where the communication quantity is closer to a communication quantity different from those transmitted and received normally.

In case that the type is “communication quantity”, it is necessary to calculate a summation of communication quantity within a window time (i.e., a certain time). Therefore, the event estimation device 101 may have a state (not shown) capable of storing communication within the window time.

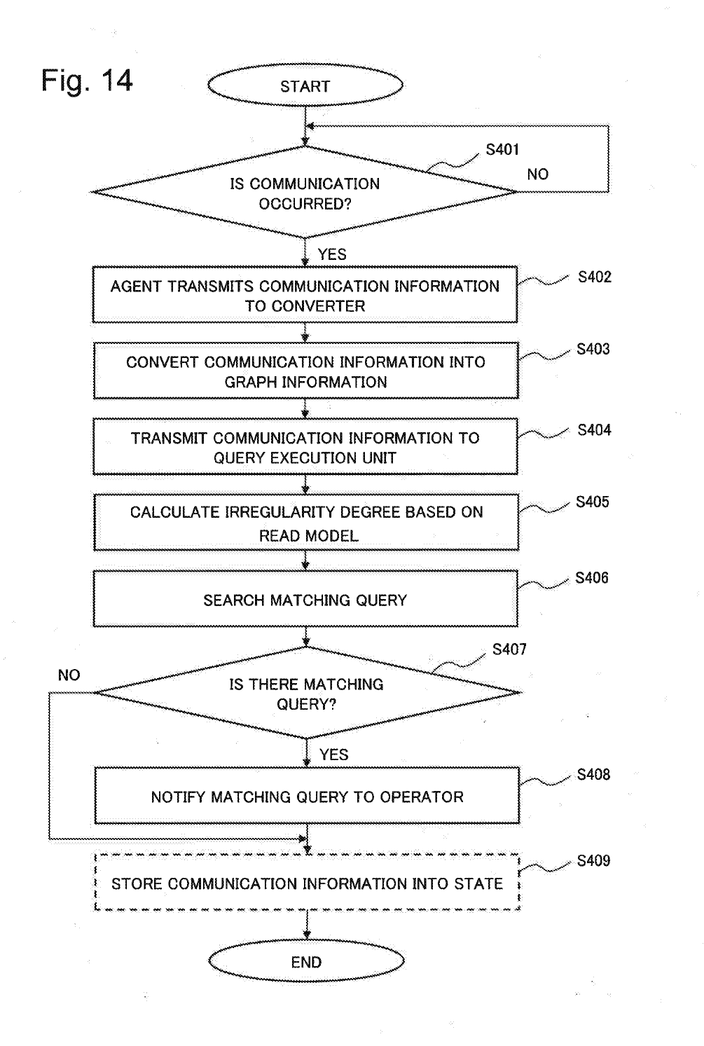

A procedure for executing processing in accordance with a query in a case where communication is executed on a host will be explained with reference to FIG. 14. FIG. 14 is a flowchart illustrating a flow of processing for generating a query.

For example, in a case where communication is executed among the host a to the host d (i.e., communication occurs) (YES in step S401), the agent a to the agent d transmit communication information about the communication to the converter (step S402). The converter receives the communication information, and converts the received communication information into graph information (step S403). The processing shown in step S401 to step S403 is similar to the processing shown in step S301 to step S303 illustrated in FIG. 7, and therefore, the processing may be shared. The converter transmits the communication information to the query execution unit 104 (step S404).

The query execution unit 104 searches a query that matches with the communication information, but in its previous stage, the query execution unit 104 calculates the irregularity degree relating to communication included in the communication information on the base of the model stored in the communication database 503 (step S405).

Hereinafter, operations for each item that can be set to the type will be explained.

First, in a case where the type is “novelty”, the query execution unit 104 reads, from the communication database 503, a model associated with the transmission host information, the reception host information, and the protocol that are included in the received communication information. The query execution unit 104 calculates the irregularity degree by applying the read model to the information about the timing when the communication is executed.

In a case where the type is “time zone”, the query execution unit 104 reads, from the communication database 503, a model associated with the transmission host information, the reception host information, and the protocol that are included in the received communication information. Then, the query execution unit 104 calculates the irregularity degree by applying the read model to the timing when the communication is executed.

In a case where the type is “communication frequency”, the query execution unit 104 reads, from the communication database 503, a model associated with the transmission host information, the reception host information, and the protocol that are included in the received communication information. The query execution unit 104 calculates a difference between a timing of the communication included in the communication information and a timing of an immediately preceding communication of the same protocol in the same section as the communication information was executed, and applies the read model to the calculated difference, so that the query execution unit 104 calculates the irregularity degree.

In a case where the type is “communication quantity”, the query execution unit 104 reads, from the communication database 503, a model associated with the transmission host information, the reception host information, and the protocol that are included in the received communication information. The query execution unit 104 calculates a summation communication quantity in communication included within a window time designated by a query with regard to any given communication with the same protocol in the same section as the communication information held in the state and the communication information, and applies the read model to the communication quantity, so that the query execution unit 104 calculates the irregularity degree.

The query execution unit 104 searches a query matching with (agreeing with) the communication information from among the storied queries (step S406). The query execution unit 104 estimates that a query matches with communication information in a case where the calculated irregularity degree is more than a threshold value. In a case where there exists a matching query (YES in step S407), the query execution unit 104 notifies the matching query to the operator 1006 via the query IF (step S408). The query execution unit 104 may store communication information for a model of a type (“communication frequency”, “communication quantity”, and the like) that requires past communication information (step S409).

Subsequently, the advantages relating to the event estimation device 101 according to the first example embodiment will be explained.

The event estimation device 101 can estimate whether a communication is irregular with a high degree of accuracy. This is because the model generation unit 102 calculates a model appropriate for calculating the irregularity degree.

The irregularity detection device disclosed in PTL 1 calculates a percentile relating to an event stored in a history on the base of the history of an occurred event. Subsequently, the irregularity detection device discovers an irregular event, based on the calculated percentile. For example, in a case where the number of occurred events is small, the history may not necessarily store the events of all the types. Therefore, the irregularity detection device does not necessarily discover an irregular event.

In contrast, the model generation unit 102 generates an appropriate model by executing the processing explained above. The model generation unit 102 generates a model in which the irregularity degree is high in a case where the communication frequency is low, and in which the irregularity degree is low in a case where the communication frequency is high. The estimation unit 103 determines whether a communication is irregular in accordance with the model. Therefore, the event estimation device 101 can estimate whether a communication is irregular with a high degree of accuracy.

Further, in a case where there is a section in which the frequency is zero, for example, the model generation unit 102 adds a small value (for example, one) to the frequency in each section, so that the model generation unit 102 can generate a model with which the irregularity degree relating to the communication can be calculated appropriately. Therefore, the event estimation device 101 accurately estimates whether a communication is irregular based on an appropriate model.

In a case where the type is “novelty”, the event estimation device 101 according to the present example embodiment can estimate whether a communication is irregular with a high degree of accuracy. This is because in many cases, communications are frequently executed within a certain period, and communications are not so much executed in a period other than the certain period.

The reason why the event estimation device 101 according to the present example embodiment can estimate whether a communication is irregular with a high degree of accuracy in a case where the type is “novelty” will be explained in details. As explained above about the processing relating to the case where the type is “novelty”, the relationship between the frequency and the irregularity degree is such that a communication of a lower frequency has a higher irregularity degree, and a communication of a higher frequency has a lower irregularity degree. In a case where communication is executed at a timing away from a period in which communications are frequently executed, the communication is likely to be irregular. In accordance with the processing explained above, the event estimation device 101 determines a communication executed at a timing away from a period in which communications are frequently executed is irregular. Therefore, the event estimation device 101 according to the present example embodiment can estimate whether a communication is irregular with a high degree of accuracy.

In a case where the type is “time zone”, the event estimation device 101 according to the present example embodiment can estimate whether a communication is irregular with a high degree of accuracy.

The reason why the event estimation device 101 according to the present example embodiment can estimate whether a communication is irregular with a high degree of accuracy in a case where the type is “time zone” will be explained. The relationship between the frequency and the irregularity degree is such that a communication executed in a time zone in which similar communication events (communications) seldom occur has a higher degree of irregularity, and a communication executed in a time zone in which similar (or the same) communications are frequently executed has a lower degree of irregularity. Therefore, the event estimation device 101 according to the present example embodiment generates a model such that a time zone with a lower frequency has a higher irregularity degree, and a time zone with a higher frequency has a lower irregularity degree to cause the model to be an appropriate model, and accordingly the irregularity of communications can be determined accurately.

In a case where the type is “communication frequency”, the event estimation device 101 according to the present example embodiment can estimate whether a communication is irregular with a high degree of accuracy.

The reason why the event estimation device 101 according to the present example embodiment can estimate whether a communication is irregular with a high degree of accuracy in a case where the type is “communication frequency” will be explained. When communications are executed with an interval different from the normal interval, this indicates that an irregular phenomenon occurs. The event estimation device 101 employs, as the frequency, an interval between a communication timing and a subsequent communication timing, and the event estimation device 101 generates a model such that in a case where the frequency of the interval is lower, the irregularity degree is higher, and in a case where the frequency of the interval is higher, the irregularity degree is lower. Therefore, the event estimation device 101 according to the present example embodiment can generate an appropriate model.

In a case where the type is “communication quantity”, the event estimation device 101 according to the present example embodiment can estimate whether a communication is irregular with a high degree of accuracy.

The reason why the event estimation device 101 according to the present example embodiment can estimate whether a communication is irregular with a high degree of accuracy in a case where the type is “communication quantity” will be explained. When an information quantity different from a normal information quantity is communicated, this indicates that an irregular phenomenon occurs. The event estimation device 101 employs, as the frequency, a communication quantity for a certain period of time, and the event estimation device 101 generates a model such that in a case where the frequency of the communication quantity is lower, the irregularity degree is higher, and in a case where the frequency of the communication quantity is higher, the irregularity degree is lower. Therefore, the event estimation device 101 according to the present example embodiment can generate an appropriate model.

Therefore, the event estimation device 101 according to the present example embodiment can estimate whether a communication is irregular with a high degree of accuracy.

### Second Example Embodiment

Subsequently, the second example embodiment of the present invention, which is based on the first example embodiment explained above, will be explained.

In the following explanation, characteristic portions relating to the present example embodiment will be mainly described, and the same reference numerals are given to the same configurations as those of the first example embodiment described above, and redundant explanation will be omitted.

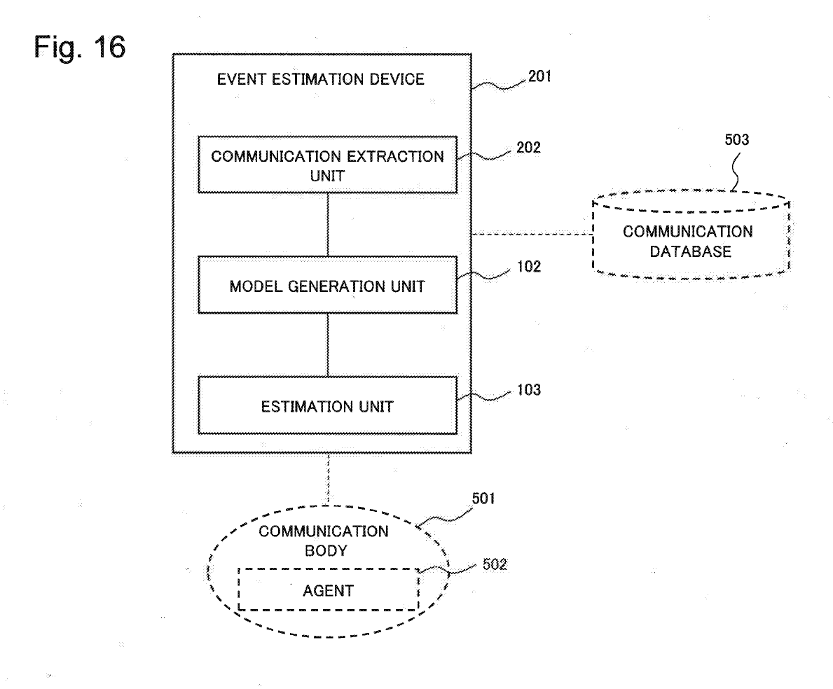

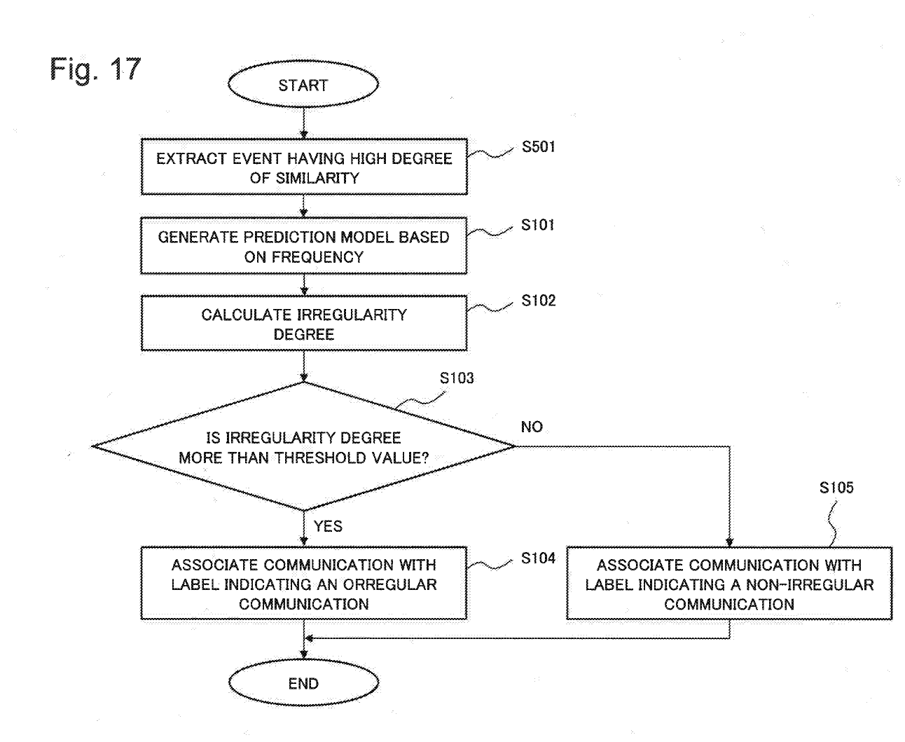

The configuration of the event estimation device 201 according to the second example embodiment and the processing performed by the event estimation device 201 will be described with reference to FIG. 16 and FIG. 17. FIG. 16 is a block diagram illustrating a configuration of the event estimation device 201 according to the second example embodiment of the present invention. FIG. 17 is a flowchart illustrating a flow of processing of the event estimation device 201 according to the second example embodiment.

The event estimation device 201 according to the second example embodiment includes a communication extraction unit 202, a model generation unit 102, and an estimation unit 103.

Graph information (for example, FIG. 9) obtained by converting communication information (for example, FIG. 8) about communication executed by communication bodies is stored in the communication database 503. The event estimation device 201 can read the graph information and the like from the communication database 503, and can store the graph information and the like to the communication database 503.

For example, in accordance with the updating of the graph information in the communication database 503, the communication extraction unit 202 reads a communication having a high degree of similarity (similarity), that represents a degree how much the communication is similar to the communication included in the updated graph information, from the communication database 503 (step S501). For convenience of explanation, the read communication will be referred to as “first communication”. In this case, a high degree of similarity indicates that certain two communications are similar or the same.

For example, in a case where various kinds of information about communications are associated with edges in the graph information, the communication extraction unit 202 may calculate the degree of similarity on the base of the information. For example, in a case where the information is represented with a symbol or a numerical value, the distance of the information can be calculated, and the distance can be employed as the degree of similarity.

In a case where the calculated degree of similarity is more than the predetermined value, the communication extraction unit 202 estimates that communication is similar to (or the same as) information included in the graph information. In a case where the calculated degree of similarity is less than the predetermined value, the communication extraction unit 202 estimates that the communication is not similar to (or not the same as) information included in the graph information.

The communication extraction unit 202 selects a communication having a high degree of similarity by executing the processing described above (step S501).

Alternatively, the communication extraction unit 202 may select similar (or the same) information by applying a clustering algorithm to the symbol or numerical value representing the information.

The model generation unit 102 generates a model relating to the communication by generating the histogram as described above with regard to the communication selected by the communication extraction unit 202 (step S101).

Subsequently, the estimation unit 103 calculates the irregularity degree by applying the generated model (step S102). The estimation unit 103 determines whether the calculated irregularity degree satisfies a criterion (step S103). In a case where the calculated degree of irregularity is more than the threshold value (YES in step S103), the estimation unit 103 associates the communication with a label indicating an irregular communication (step S104). In a case where the calculated irregularity degree does not satisfy the criterion (NO in step S103), the estimation unit 103 associates the communication with a label indicating a non-irregular communication (step S105). In step S104 or step S105, the estimation unit 103 associates the communication with the label, but the estimation unit 103 may classify the communication into an irregular communication and a non-irregular communication on the base of whether the irregularity degree is more than the threshold value.

Subsequently, the effects of the event estimation device 201 according to the second example embodiment will be explained.

The event estimation device 201 according to the present example embodiment can estimate whether a communication is irregular with a still higher degree of accuracy. This reason includes Reason 1 and Reason 2.

(Reason 1) The configuration of the event estimation device 201 according to the second example embodiment includes the configuration of the event estimation device 101 according to the first example embodiment.

(Reason 2) The communication extraction unit 202 selects a communication having a high similarity degree so that the model generation unit 102 can generate an appropriate model.

(Hardware Configuration Example)

A configuration example of hardware resources that realize an event estimation in the above-described example embodiments of the present invention using a single calculation processing apparatus (an information processing apparatus or a computer) will be described. However, the availability analysis device may be realized using physically or functionally at least two calculation processing apparatuses. Further, the availability analysis device may be realized as a dedicated apparatus.

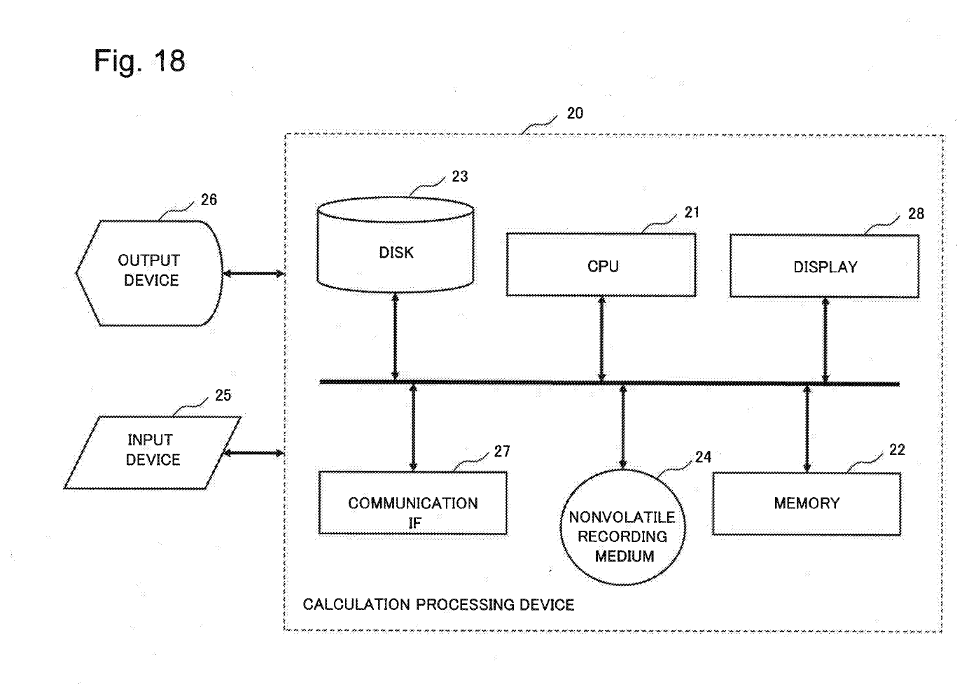

FIG. 18 is a block diagram schematically illustrating a hardware configuration of a calculation processing apparatus capable of realizing the event estimation device according to each of the first to second example embodiments. A calculation processing apparatus 20 includes a central processing unit (CPU) 21, a memory 22, a disc 23, a non-transitory recording medium 24, a communication interface (hereinafter, expressed as a “communication I/F”) 27 and a display 28. A calculation processing apparatus 20 further includes an input apparatus 25 and an output apparatus 26. The calculation processing apparatus 20 can execute transmission/reception of information to/from another calculation processing apparatus and a communication apparatus via the communication I/F 27.

The non-volatile recording medium 24 is, for example, a computer-readable Compact Disc, Digital Versatile Disc, Universal Serial Bus (USB) memory, or Solid State Drive. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory medium 24.

In other words, the CPU 21 copies, on the memory 22, a software program (a computer program: hereinafter, referred to simply as a “program”) stored by the disc 23 when executing the program and executes arithmetic processing. The CPU 21 reads data necessary for program execution from the memory 22. When display is needed, the CPU 21 displays an output result on the display 28. When a program is input from the outside, the CPU 21 reads the program from the input apparatus 25. The CPU 21 interprets and executes an event estimation program present on the memory 22 corresponding to a function (processing) indicated by each unit illustrated in FIG. 1, FIG. 15, or FIG. 16 described above or an event estimation program (FIG. 2, FIG. 3, FIG. 7, FIG. 14 or FIG. 17). The CPU 21 sequentially executes the processing described in each example embodiment of the present invention.

In other words, in such a case, it is conceivable that the present invention can also be made using the event estimation program. Further, it is conceivable that the present invention can also be made using a computer-readable, non-transitory recording medium storing the event estimation program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

This application is based upon and claims the benefit of priority from Japanese patent application No. 2014-184088, filed on Sep. 10, 2014, the disclosure of which is incorporated herein in its entirety.

### REFERENCE SIGNS LIST

101 Event estimation device

102 Model generation unit

103 Estimation unit

104 Query execution unit

503 Communication database

a Vertex

b Vertex

c Vertex

d Vertex

201 Event estimation device

202 Communication extraction unit

301 Type IF

302 Threshold value IF

303 Option IF

304 Transmission host IF

305 Reception host IF

306 Protocol IF

20 Calculation processing device

21 CPU

22 Memory

23 Disk

24 Non-volatile recording medium

25 Input device

26 Output device

27 Communication IF

28 Display

1001a Host

1002a Agent

1001b Host

1002b Agent

1001c Host

1002c Agent

1001d Host

1002d Agent

1003 Converter

1004 Communication database

1005 Interface

1006 Operator

1. An event estimation device comprising:
a model generation unit configured to generate, based on a frequency of communications, a model for calculating an irregularity degree, that represents how irregular a communication is, which is high if the frequency is low and which is low if the frequency is high; and
an estimation unit configured to calculate the irregularity degree by applying the model to a frequency of a certain communication, and estimate that the certain communication is irregular if the calculated irregularity degree satisfies a criterion and that, otherwise, the certain communication is non-irregular.

2. The event estimation device according to claim 1, further comprising:
a communication extraction unit configured to extract, as first communications, communications similar to the certain communication or communications the same as the certain communication from communication information including a history relating to executed communications,
wherein the model generation unit generates the model, based on the first communications.

3. The event estimation device according to claim 2, wherein
the frequency is a frequency of execution in a period of periods obtained by classifying timings of the first communications to the periods.

4. The event estimation device according to claim 2, wherein
the frequency is a frequency of execution in a time zone relating to a timing when the first communications are executed.

5. The event estimation device according to claim 2, wherein
the frequency is a frequency relating to an interval from a timing when each of the first communications is executed to a timing when the subsequent of the each is executed.

6. The event estimation device according to claim 2, wherein
the frequency is a frequency of measuring a certain communication quantity with regard to communications transmitted and received in the first communications within a certain period of time.

7. The event estimation device according to claim 1, further comprising:
an interface capable of designating a type of the frequency and a parameter serving as the criterion,
wherein the model generation unit generates the model, based on the frequency of the type, and
the estimation unit determines whether the certain communication is irregular based on the parameter serving as the criterion.

8. An event estimation method comprising:
generating, based on a frequency of communications, a model for calculating an irregularity degree, that represents how irregular a communication is, which is high if the frequency is low and which is low if the frequency is high, calculating the irregularity degree by applying the model to a frequency of a certain communication, and estimating that the certain communication is irregular if the calculated irregularity degree satisfies a criterion and that, otherwise, the certain communication is non-irregular.

9. A non-volatile recording medium having an event estimation program recorded therein, the program making a computer achieve:
a model generation function configured to generate, based on a frequency of communications, a model for calculating an irregularity degree, that represents how irregular a communication is, which is high if the frequency is low and which is low if the frequency is high; and
an estimation function configured to calculate the irregularity degree by applying the model to a frequency of a certain communication, and estimate that the certain communication is irregular if the calculated irregularity degree satisfies a criterion and that, otherwise, the certain communication is non-irregular.

10. The non-volatile recording medium having the event estimation program according to claim 9, further comprising:
a communication extraction function configured to extract, as first communications, communications similar to the certain communication or communications the same as the certain communication from communication information including a history relating to executed communications,
wherein the model generation function generates the model, based on the first communications.
